(19) United States
(12) Patent Application Publication
(10) Pub. No.: US 2025/0363704 A1
(43) Pub. Date: Nov. 27, 2025

(54) AVATAR GENERATION SYSTEM, AVATAR GENERATION METHOD, AND STORAGE MEDIUM

(71) Applicant: TOPPAN Holdings Inc., Tokyo (JP)

(72) Inventors: Tomoaki NAKAYAMA, Tokyo (JP); Ping ZHANG, Tokyo (JP); Nanami SHIMIZUGAWA, Tokyo (JP)

(73) Assignee: TOPPAN Holdings Inc., Tokyo (JP)

(21) Appl. No.: 19/213,265

(22) Filed: May 20, 2025

(30) Foreign Application Priority Data
May 21, 2024 (JP) 2024-082455
Mar. 11, 2025 (JP) 2025-038166

(51) Int. Cl. G06T 13/40; G06F 40/40; G06T 13/20; G10L 13/027; G10L 13/033; G10L 13/08

(52) U.S. Cl. CPC G06T 13/40; G06F 40/40; G06T 13/205; G10L 13/027; G10L 13/033; G10L 13/086

(57) ABSTRACT

An avatar generation system according to one aspect of the present disclosure includes a receiver configured to receive persona information indicating a persona that characterizes a dialogue partner of a user, a persona generator configured to generate a persona generation prompt indicating characteristics of the persona based on the persona information received by the receiver using a large language model, a storage configured to store a plurality of pieces of element data indicating components of an avatar as a dialogue partner, an avatar generator configured to select the element data stored in the storage for the persona generation prompt generated by the persona generator and generate an avatar using the selected element data, and an output unit configured to output an avatar corresponding to the persona based on the persona generation prompt generated by the persona generator.

### CROSS-REFERENCE TO RELATED APPLICATIONS

The present application claims priority based on Japanese Patent Application No. 2024-082455 filed May 21, 2024, and Japanese Patent Application No. 2025-038166 filed Mar. 11, 2025, the contents of each are incorporated herein by reference.

### BACKGROUND OF THE INVENTION

### Field of the Invention

The present invention relates to an avatar generation system, an avatar generation method, and a storage medium.

### Description of Related Art

In the related art, there is known a technology for generating a character, called an avatar, which virtually represents a person in a virtual space. For example, a virtual pseudo-human image generation system described in Japanese Patent No. 3153141 stores a movement pattern of a virtual pseudo-human image model and model data of the virtual pseudo-human image model, and generates a moving virtual pseudo-human image by applying the movement pattern to the model data. In this virtual pseudo-human image generation system, an idling movement pattern for giving the virtual pseudo-human image model an idling movement of slightly moving the head and body is stored, and in a case where the virtual pseudo-human image model to be generated does not move for a certain period of time, the idling movement pattern is read out and a virtual pseudo-human image model with an idling movement is generated.

### SUMMARY OF THE INVENTION

However, although the above-mentioned virtual pseudo-human image generation system generates a virtual pseudo-human image model using the movement patterns and model data of the virtual pseudo-human image model, it is not possible to generate an avatar according to the attributes of a dialogue partner.

The present disclosure has been made in consideration of the above circumstances, and an object of the present disclosure is to provide an avatar generation system, an avatar generation method, and a storage medium that can easily generate an avatar according to the attributes of a dialogue partner.

The present disclosure has been made to solve the above-described problems, and one aspect of the present disclosure is an avatar generation system including: a receiver configured to receive persona information indicating a persona that characterizes a dialogue partner of a user; a persona generator configured to generate a persona generation prompt indicating characteristics of the persona based on the persona information received by the receiver using a large language model; a storage storing a plurality of pieces of element data indicating components of an avatar as a dialogue partner; an avatar generator configured to select the element data stored in the storage for the persona generation prompt generated by the persona generator and generate an avatar using the selected element data; and an output unit configured to output the avatar corresponding to the persona based on the persona generation prompt generated by the persona generator.

Another aspect of the present disclosure is an avatar generation method including: a step in which an avatar generation system stores, in a storage, a plurality of pieces of element data indicating components of an avatar as a dialogue partner of a user; a step in which the avatar generation system receives persona information indicating a persona that characterizes the dialogue partner of the user; a step in which the avatar generation system generates a persona generation prompt indicating characteristics of the persona based on the received persona information using a large language model; a step in which the avatar generation system selects the element data stored in the storage for the generated persona generation prompt and generates an avatar using the selected element data; and a step in which the avatar generation system outputs the avatar corresponding to the persona based on the generated persona generation prompt.

Another aspect of the present disclosure is a non-transitory computer-readable storage medium storing a program that causes a computer of an avatar generation system to execute: a step in which the avatar generation system stores, in a storage, a plurality of pieces of element data indicating components of an avatar as a dialogue partner of a user; a step in which the avatar generation system receives persona information indicating a persona that characterizes the dialogue partner of the user; a step in which the avatar generation system generates a persona generation prompt indicating characteristics of the persona based on the received persona information using a large language model; a step in which the avatar generation system selects the element data stored in the storage for the generated persona generation prompt and generates the avatar using the selected element data; and a step in which the avatar generation system outputs an avatar corresponding to the persona based on the generated persona generation prompt.

According to one aspect of the present invention, it is possible to easily generate an avatar according to the attributes of a dialogue partner.

### BRIEF DESCRIPTION OF THE DRAWINGS

FIG. 1 is a block diagram showing a configuration example of a dialogue support system 1 according to an embodiment.

FIG. 2 is a diagram showing an outline of processing performed by the dialogue support system 1 according to the embodiment.

FIG. 3 is a flowchart showing an example of a processing procedure of the dialogue support system 1 according to the embodiment.

FIG. 4 is a diagram showing an example of customer-defined information including a variable name and a character string according to the embodiment.

FIG. 5 is a diagram showing an example of a persona generation prompt in the embodiment.

FIG. 6 is a diagram showing an example of variables generated from a persona generation prompt in the embodiment.

FIG. 7 is a diagram showing an example of preset data included in element data in the embodiment.

FIG. 8 is a diagram showing an example of a persona designation prompt in the embodiment.

FIG. 9 is a diagram showing an example of persona designation information in the embodiment.

### DETAILED DESCRIPTION OF THE INVENTION

An avatar generation system, an avatar generation method, and a storage medium to which the present invention is applied will be described below with reference to the drawings.

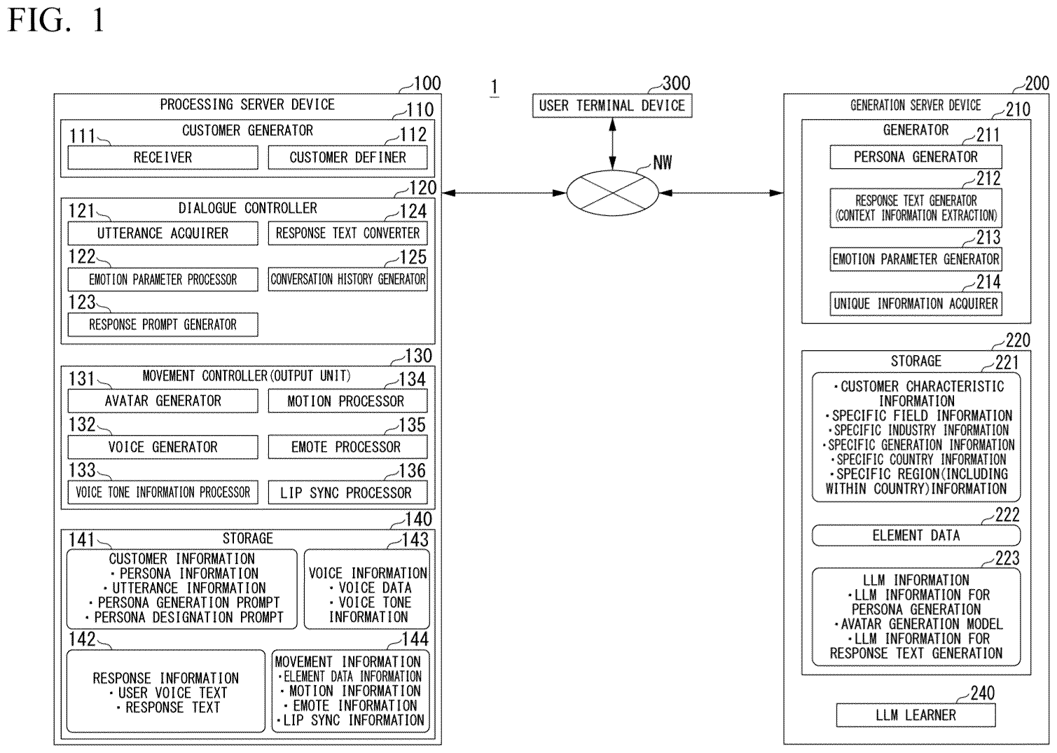

FIG. 1 is a block diagram showing a configuration example of a dialogue support system 1 according to an embodiment.

The dialogue support system 1 according to the embodiment supports a dialogue between a user and an avatar characterized by a specific persona. The dialogue support system 1 generates a persona based on information designated by a user, for example, and controls an avatar corresponding to the generated persona, so that the user and the avatar perform a role play. A role play is, for example, training for new employees, sales training, language training, communication training, and the like by using a virtual avatar as a dialogue partner with the user. Furthermore, a role play in the embodiment includes playing between people of different nationalities and places of origin.

The dialogue support system 1, for example, includes a processing server device 100, a generation server device 200, and a user terminal device 300. The processing server device 100, the generation server device 200, and the user terminal device 300 are communicatively connected via a network NW such as the Internet. The processing server device 100, the generation server device 200, and the user terminal device 300 may be connected to each other via either wired or wireless communication, and may include a general-purpose network such as the Internet, and a private network such as local 5G or WiFi (registered trademark). The processing server device 100, the generation server device 200, and the user terminal device 300 may each have a communication interface, such as a network interface card (NIC) or a wireless communication module, for connecting to a network, and may exchange information with one another.

The user terminal device 300 is, for example, an information processing device operated by a user who has a dialogue with an avatar. The user terminal device 300, for example, includes a speaker, a microphone, a display device, an operation unit, and a processing unit such as a CPU.

The processing server device 100, for example, includes a processor that performs processing in response to requests received from the generation server device 200 and the user terminal device 300, and transmits processing results to the generation server device 200 and the user terminal device 300. The processing server device 100, for example, includes a customer generator 110, a dialogue controller 120, a movement controller 130, and a storage 140. The customer generator 110, the dialogue controller 120, and the movement controller 130 are functional units realized by an information processing circuit that performs various processes by causing a central processing unit (CPU) to execute a program, for example. Further, some or all of these functional units may be realized by hardware such as large scale integration (LSI), application specific integrated circuit (ASIC), or field-programmable gate array (FPGA), or may be realized by cooperation of software and hardware. The storage 140 is realized, for example, by a hard disk drive (HDD), a solid state drive (SSD), a flash memory, an electrically erasable programmable read only memory (EEPROM), a read only memory (ROM), or a random access memory (RAM), or a hybrid storage device that uses a plurality of these. A part or the whole of the storage 140 may be realized by an external storage device that can be accessed via various networks. An example of an external storage device is a network attached storage (NAS) device.

The customer generator 110 generates customer information. The customer information indicates the customers assumed by the user. The customer corresponds to an avatar that is a dialogue partner of the user in a role play, for example. The customer generator 110, for example, includes a receiver 111 and a customer definer 112. The receiver 111 receives persona information based on information received from the user terminal device 300. The persona information is customer-defined information that indicates a persona that characterizes a customer (dialogue partner) for the user. A persona may be a virtual character, or a character based on information about a real person. In addition, the persona information may be based in part on information about a person who actually exists, or on information about a person who has already passed away. The customer definer 112 generates customer information based on the persona information received by the receiver 111.

The dialogue controller 120 controls an avatar corresponding to a persona based on a persona generation prompt generated by a persona generator 211, and performs processing for controlling the dialogue between the avatar and the user. The dialogue controller 120, for example, includes an utterance acquirer 121, an emotion parameter processor 122, a response prompt generator 123, a response text converter 124, and a conversation history generator 125.

The utterance acquirer 121 acquires utterance information that indicates a user's utterance input from the user terminal device 300, and converts the acquired utterance information into text data.

The emotion parameter processor 122 performs processing for setting and updating emotion parameters. The emotion parameter is a numerical value indicating the emotion of the avatar (customer). The emotion parameters are, for example, information that express emotions such as joy, anger, sadness, enjoyment, confidence, confusion, and fear on a five-level scale from 1 to 5. In the present embodiment, the configuration related to the emotion of the customer, such as the emotion parameter processor 122, will be described, but the present invention is not limited thereto, and the configuration related to the emotion of the customer may not be provided.

The response prompt generator 123 generates a response prompt including text data of the user's voice and emotion parameters, and transmits the generated response prompt to the generation server device 200.

The response text converter 124 converts the response text acquired from the generation server device 200 into voice data.

The conversation history generator 125 generates history information indicating the history of conversations between a user and an avatar.

The movement controller 130 performs processing for controlling the movement of the avatar. The movement controller 130, for example, includes an avatar generator 131, a voice generator 132, a voice tone information processor 133, a motion processor 134, an emote processor 135, and a lip sync processor 136.

The avatar generator 131 selects element data stored in the storage 140 in response to the persona generation prompt generated by the persona generator 211, and generates an avatar using the selected element data. The element data for generating an avatar is, for example, image data that indicates basic body features such as the face and body of the avatar corresponding to an age group, a gender, a nationality, or a place of origin. The element data for generating an avatar may include image data that indicates clothing.

The voice generator 132 generates voice data to be output to the user based on the element data stored in the storage 140. The voice generator 132 generates voice data that reproduces, for example, the customer's natural voice.

The element data stored in the storage 140 may include element data for generating a voice.

The element data for generating a voice is, for example, synthesized voice data corresponding to an age group, a gender, a nationality, or a place of origin. The element data for generating a voice may be synthesized voice data corresponding to elements including, for example, a speaking style (for example, a habitual phrase, an interjection, a dialect), a tone (for example, a speaking speed), a pitch of the voice, or a tone of the voice. The speaking style and tone may reflect the general speaking style and culture specific to a predetermined country or region. Differences in speaking style may arise, for example, from differences in the number of vowels used in different countries or regions.

In the embodiment, the persona information may include a nationality or a place of origin. The persona generator 211 may input existing items including the persona's nationality or place of origin as persona information into a large language model, and generate a persona generation prompt based on an output of the large language model.

The element data may include element data for generating a voice, and the element data for generating a voice may include synthesized voice data corresponding to elements including a speaking style or a tone corresponding to the persona's nationality or place of origin. Accordingly, the voice generator 132 can generate voice data in a language corresponding to the nationality or the place of origin based on the persona generation prompt and the persona information generated by the persona generator 211.

Accordingly, the voice generator 132 can control the voice (a voice tone, a pitch of the voice, a tone, and the like) using synthesized voice data that corresponds to the speaking style and the tone.

Element data for generating the voice may include a plurality of pieces of element data corresponding to a plurality of languages. The voice generator 132 can select one of a plurality of pieces of element data corresponding to each of a plurality of languages stored in the storage 140 based on the nationality or the place of origin included in the persona information. Accordingly, the voice generator 132 generates voice data using synthesized voice data corresponding to each of the multiple languages. In addition, the voice generator 132 can control the voice to reflect the general speaking style and culture specific to a country or region so that the user and the dialogue partner have different nationalities or places of origin. For example, the voice generator 132 may generate voice data to change the voice into a voice specific to the country or region of the dialogue partner.

Furthermore, in the dialogue support system 1, the voice may be automatically translated in real time into a language of a country or region different from the user's nationality or place of origin, and the voice generator 132 may generate voice data.

Furthermore, in the dialogue support system 1, voice data may be generated by the voice generator 132 to speak or respond to a voice that reflects the general speaking style and culture specific to a specific country or region, in a language selected from multiple languages.

The voice tone information processor 133 processes the voice data based on the element data, the emotion parameters, or the voice tone information corresponding to the content of the response text stored in the storage 140.

The motion processor 134 controls the motion of the avatar based on the element data, the emotion parameters, or the content of the response text stored in the storage 140. For example, the motion of the avatar represents the movement of the entire avatar or the movement of the avatar's hands. The element data may include element data for generating a motion. The element data for generating a motion is, for example, an avatar image that corresponds to various gestures. The various gestures include, for example, a youthful gesture, an arrogant gesture, and the like.

The motion processor 134 may control the motion of the avatar so that the motion reflects general gestures, hand movements, and culture specific to a predetermined country or region. The element data for generating a motion represents an avatar motion corresponding to a nationality or a place of origin, and the persona information may include the nationality or the place of origin. The motion processor 134 can generate an avatar motion corresponding to the nationality or the place of origin based on the persona generation prompt and the persona information generated by the persona generator 211.

The emote processor 135 controls the facial expression of the avatar based on the element data, the emotion parameters, and the content of the response text stored in the storage 140. The emote processor 135 controls the movements of the avatar's eyes, eyebrows, mouth, and the like, for example. The element data for generating an emote is, for example, an avatar image that corresponds to various facial expressions of the avatar. The various facial expressions include, for example, a youthful facial expression, a calm facial expression, and the like.

The lip sync processor 136 controls the movement of the avatar's lips based on emotion parameters and the content of the response text.

The movement controller 130 functions as an output unit that outputs an avatar corresponding to a persona based on a persona generation prompt generated by the persona generator 211.

The storage 140 stores, for example, customer information 141, response information 142, voice information 143, and movement information 144. The customer information 141, for example, includes persona information, utterance information, persona generation prompts, and persona designation prompts. The persona generation prompt is detailed information for generating a persona. The persona designation prompt is information that indicates the persona that is designated when the user and the avatar actually have a dialogue such as a role play.

The response information 142, for example, includes user voice text and response text, and may include an initial emotion parameter value and a current emotion parameter value. The voice information 143, for example, includes voice data such as a user voice and a response voice, and voice tone information, and may include an emotion parameter.

The movement information 144 includes pool data that includes a plurality of pieces of element data. The element data includes element data related to a face or a body, element data related to a voice, and element data related to a movement. The element data may also include element data related to clothing and element data related to facial expressions.

The element data may include descriptive text information in the element data of the avatar. The descriptive text information is text data for describing the face and facial expression of the avatar. The avatar generator 131 collates the persona generation prompt with the descriptive text information, and selects or generates image information of an avatar for the persona based on the collation result. The avatar generator 131 selects element data that corresponds to a descriptive text as the degree of match between the persona generation prompt and the descriptive text information increases.

The generation server device 200, for example, performs processing in response to a request received from the processing server device 100 and transmits the processing result. The generation server device 200, for example, includes a generator 210, a storage 220, and an LLM learner 240. The generator 210 and the LLM learner 240 are functional units realized by an information processing circuit that performs various processes by causing a CPU to execute a program, for example. The storage 220 is realized, for example, by a recording device such as an HDD or an SSD, or a hybrid storage device that uses a plurality of these, and may also be realized by an external storage device that can be accessed via various networks, such as a NAS device.

The generator 210, for example, includes the persona generator 211, a response text generator 212, and a unique information acquirer 214.

The persona generator 211 inputs the persona information acquired from the processing server device 100 into a first large language model, and generates a persona generation prompt based on an output of the first large language model. The persona generator 211 may input persona information and information related to a specific field into a first large language model, and generate a persona generation prompt indicating characteristics of a persona corresponding to the specific field based on an output of the first large language model. The information related to a specific field is various types of information related to a field that is a topic of the dialogue. The information related to a specific field is, for example, customer characteristic information such as customer issues related to product purchases that are empirically assumed according to a specific industry, a specific generation, a specific nationality, or a specific place of origin. The information related to a specific field is acquired as unique information by the unique information acquirer 214.

The response text generator 212 generates a response text from the response prompt generated by the response prompt generator 123, the conversation history generated by the conversation history generator 125, and the unique information acquired by the unique information acquirer 214. The response text generator 212 inputs, for example, a response prompt, a conversation history between the user and the avatar, and unique information into a second large language model, and generates a response text based on the second large language model. The response text generator 212 may extract context information of the conversation and generate a response text based on the context information in addition to the response prompt, the conversation history, and the unique information. The first large language model is a large language model (LLM) using a neural network, for example. The second large language model may be the same LLM as the first large language model, or they may be different LLMs.

The emotion parameter generator 213 generates or updates emotion parameters according to the content of the generated response text.

The unique information acquirer 214 acquires unique information which is information unique to a dialogue such as a role play. The unique information is acquired from a storage device having, for example, customer characteristic information, specific field information, specific industry information, specific generation information, specific country information, and specific region information, which are not shown.

The storage 220 stores, for example, unique information 221, element data 222, and LLM information 223.

The unique information 221 includes customer characteristic information, specific field information, specific industry information, specific generation information, specific country information, specific region (including within a country) information, and the like. The customer characteristic information indicates the characteristics of a customer who dialogues with the user. The customer characteristic information is, for example, information such as an age, a gender, an occupation, a speaking style, a personality, a nationality, and a place of origin. The specific field information indicates the field of the dialogue between the user and the customer. The specific industry information indicates the industry of the dialogue between the user and the customer. The specific generation information indicates a generation of the customer. The specific country information indicates the country to which the customer belongs (nationality, country of residence), the country of origin of the customer, or the like. The specific region (including within a country) information indicates the region to which a customer belongs, the region from which the customer originates, or the like, and the region is a part of a specific country or a collective term for a plurality of specific countries.

The element data 222 is stored in the processing server device 100. The element data 222 stored in the storage 220 may, for example, be transmitted to the processing server device 100 together with a persona generation prompt, may be transmitted to the processing server device 100 together with response text information, or may be transmitted to the processing server device 100 together with unique information.

The LLM information 223 is parameter information of an LLM (a first large language model) for generating a persona generation prompt. The LLM information 223 may include parameter information for an LLM that generates a persona designation prompt based on a persona generation prompt. The LLM information 223 may include parameter information for an LLM (a second large language model) for generating response text based on the persona designation prompt. The LLM information 223 may include parameter information for an LLM that generates an evaluation prompt based on the conversation history. In addition, the LLM for generating the persona generation prompt, the LLM for generating the persona designation prompt, the LLM for generating the response text, and the LLM for generating the evaluation prompt may be a single LLM or may be different LLMs.

The LLM learner 240 performs processing for learning an LLM (a first large language model) for generating a persona generation prompt and an LLM (a second language model) for generating response text. In addition, the LLM learner 240 may learn an LLM that generates a persona designation prompt, and may learn an LLM that generates an evaluation prompt.

In the embodiment, as shown in FIG. 1, the dialogue support system 1 distributes the functional configuration (functional units) between the processing server device 100 and the generation server device 200. However, the present invention is not limited thereto, and the functional units may be distributed in other configurations, the functional units of the processing server device 100 and the generation server device 200 may be aggregated into one device, a plurality of functional units may be combined into one functional unit, or one function may be distributed among a plurality of functional units. The function of outputting an avatar by the receiver 111, the persona generator 211, the storage 220 or the storage 140, the avatar generator 131, and the movement controller 130 corresponds to an avatar generation system.

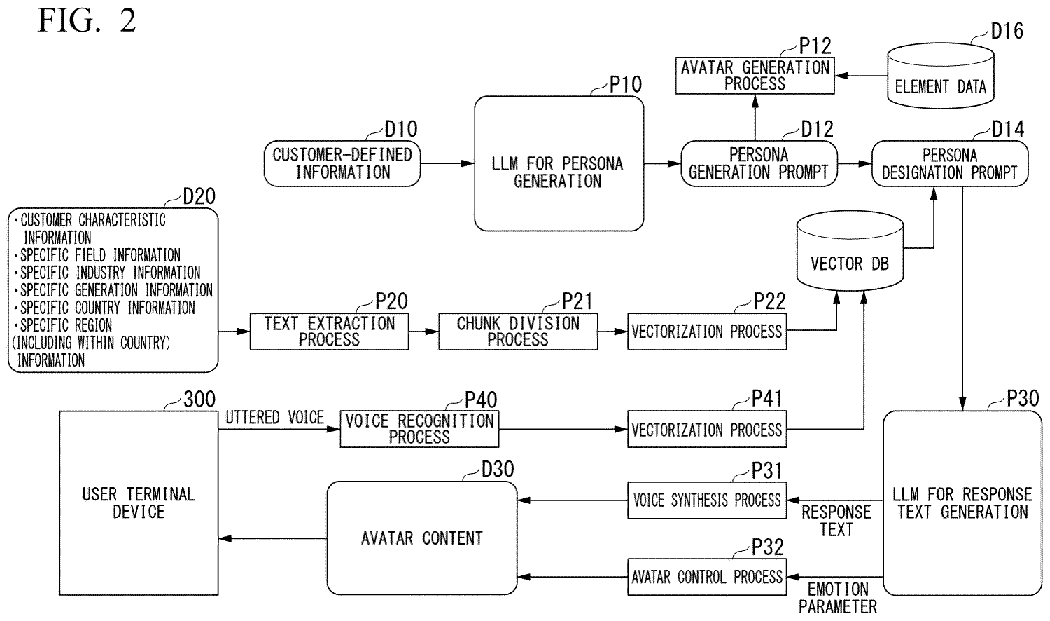

FIG. 2 is a diagram showing an outline of processing performed by the dialogue support system 1 according to the embodiment.

The receiver 111 and the customer definer 112 generate customer-defined information D10 and transmit the customer-defined information D10 to the generation server device 200. The persona generator 211 inputs the customer-defined information D10 to an LLM for persona generation (P10), and generates a persona generation prompt D12 based on an output of the LLM for persona generation (P10). The avatar generator 131 performs an avatar generation process (P12) based on the persona generation prompt D12 and element data D16. The persona generator 211 generates a persona designation prompt D14 when the user performs a role play. The persona designation prompt D14 is output to an LLM for response text generation.

The generation server device 200 acquires unique information D20 such as a specific field for performing a role play, and processes the unique information D20 in the following order: a text extraction process P20, a chunk division process P21, and a vectorization process P22, and stores vectors corresponding to the unique information D20 in a vector database (the storage 220). The processing server device 100 performs a voice recognition process P40 on the user's uttered voice acquired from the user terminal device 300, and performs a vectorization process P41 on text information processed by the voice recognition process P40, and a reference result to a vector database using a vector corresponding to the uttered voice as a query is extracted from the vector database. The vectorized unique information D20 and the text information processed by the voice recognition process P40 are output to an LLM for response text generation (P30) together with the persona designation prompt D14.

The generation server device 200 inputs the persona designation prompt D14, the unique information D20, and the text information processed by the voice recognition process P40 into the LLM for response text generation (P30), performs a voice synthesis process P31 on the response text output from the LLM for response text generation (P30), and performs an avatar control process P32 based on the emotion parameters output from the LLM for response text generation (P30) and the avatar generated by the avatar generation process (P12), thereby transmitting avatar content D30 to the user terminal device 300. Accordingly, the user terminal device 300 can perform display or voice output using the avatar content D30.

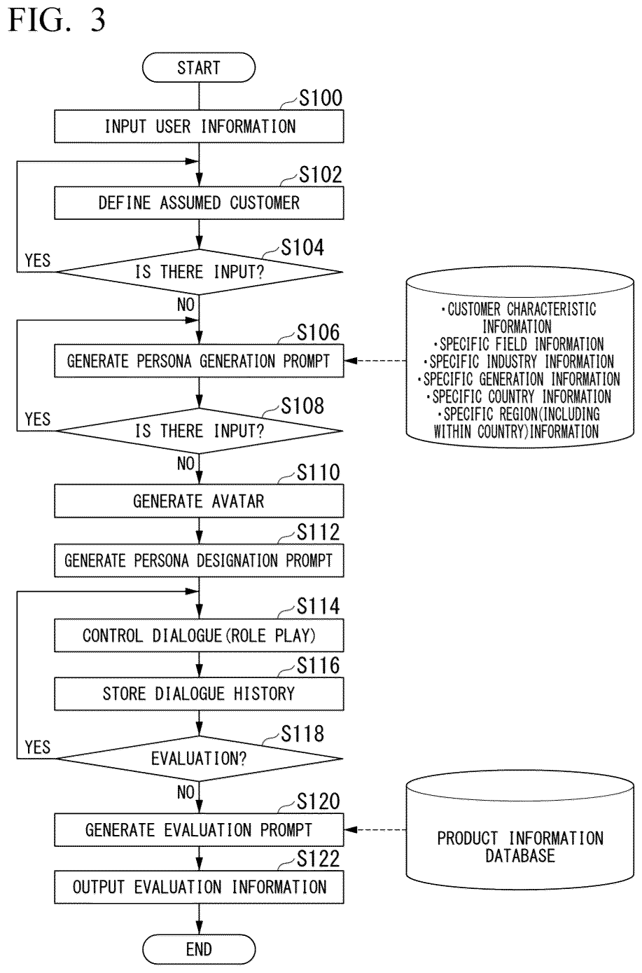

FIG. 3 is a flowchart showing an example of a processing procedure of the dialogue support system 1 according to the embodiment.

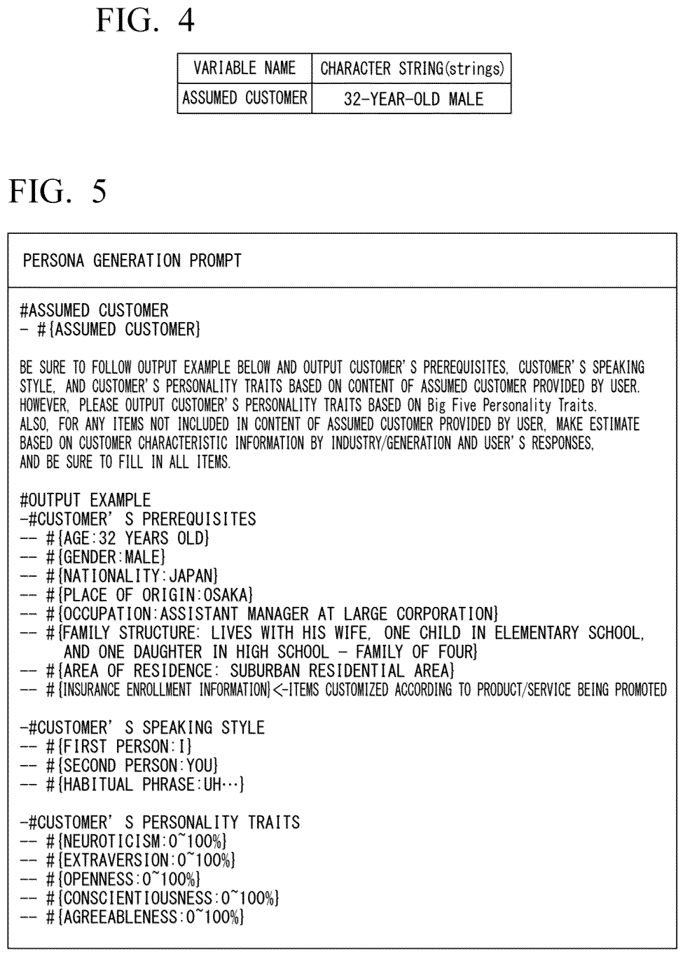

First, the processing server device 100 inputs user information related to a user who will dialogue with an avatar (step S100). The user information is character string data that characterizes a user, such as a new employee, a sales manager, a specific nationality, or a place of origin. Next, the processing server device 100 defines the customers assumed by the user (step S102). At this time, the processing server device 100 receives persona information indicating a persona that characterizes the dialogue partner of the user from the user terminal device 300 via the receiver 111, and holds the persona information as a variable, for example, as shown in FIG. 4.

FIG. 4 is a diagram showing an example of customer-defined information including a variable name and a character string according to the embodiment. The receiver 111 determines whether or not there is any further input (step S104), and in a case where an input is received, the process of step S102 is repeated, and in a case where no input is received, the customer-defined information is confirmed. The processing server device 100 transmits the customer-defined information to the generation server device 200.

The persona generator 211 inputs the customer-defined information and the unique information stored in the storage 220 to the LLM for persona generation, and generates a persona generation prompt based on an output of the LLM for persona generation (step S106).

FIG. 5 is a diagram showing an example of a persona generation prompt in the embodiment. The persona generation prompt includes, for example, text data that describes the prerequisites of the customer, the speaking style of the customer, and the personality traits of the customer. The prerequisites of the customer include, for example, items according to the role play, such as an age, a gender, an occupation, a family structure, an area of residence, a nationality, a place of origin, and insurance enrollment information. For example, in a case where a customer's place of origin is Osaka as a prerequisite, a prompt corresponding to the Kansai dialect can be generated as a persona generation prompt, and it is also possible to control the tone or dialect depending on the area of residence. Furthermore, by setting, as a prerequisite of the customer, for example, the place of origin as California, it is possible to generate a persona generation prompt capable of reproducing a person who is strongly influenced by California culture.

The speaking style of the customer may be, for example, first person, second person, habitual phrase, dialect, and the like. The personality traits of the customer may be, for example, neuroticism, extraversion, openness, conscientiousness, agreeableness, and the like. The persona generator 211 determines whether or not there is any input for other items and the like from the user terminal device 300 (step S108), and in a case where an input is received, the process of step S106 is repeated, and in a case where no input is received, the persona generation prompt is confirmed.

The persona generator 211 stores the generated persona generation prompts as variables in the storage 220.

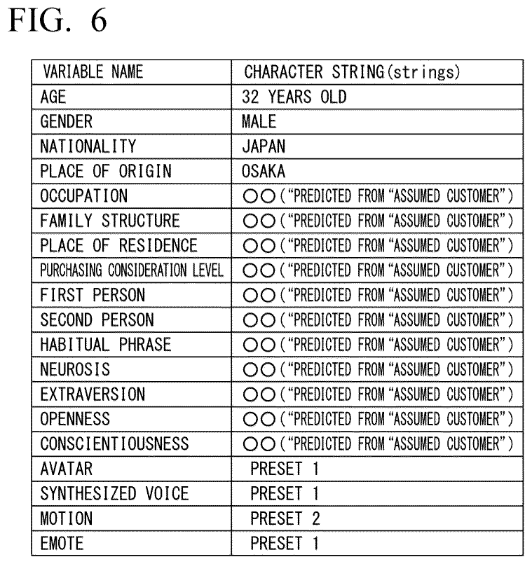

FIG. 6 is a diagram showing an example of variables generated from a persona generation prompt in the embodiment. The variables generated from the persona generation prompt are information predicted based on an output of the LLM for persona generation after inputting customer-defined information into the LLM for persona generation. The variables generated from the persona generation prompts include variables corresponding to customer-defined information such as an age, a gender, a nationality, a place of origin (including within a country), a speaking style, a tone, and a dialect, variables predicted from customer-defined information such as an occupation and a family structure, and element data variables corresponding to the variables predicted from the customer-defined information. The element data variables include, for example, a variable indicating which preset data in element data of the avatar, a variable indicating which preset data in element data of the synthesized voice, a variable indicating which preset data in element data of the motion, and a variable indicating which preset data in element data of the emote.

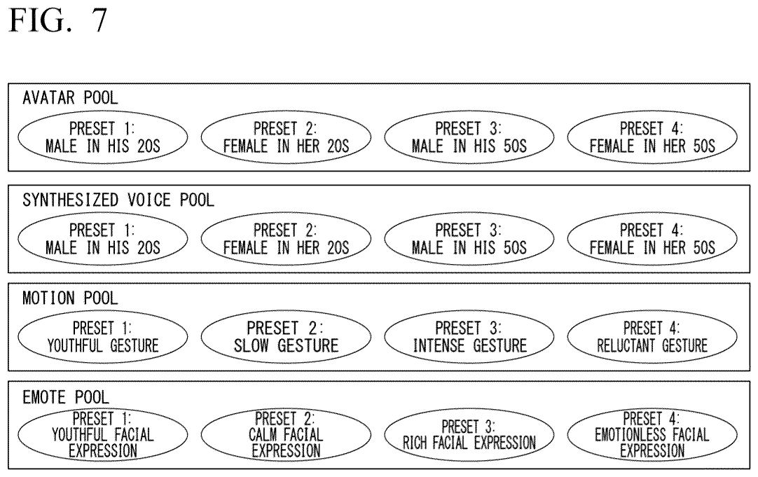

FIG. 7 is a diagram showing an example of preset data included in element data in the embodiment. For example, a plurality of pieces of preset data are set for each of an avatar pool, a synthesized voice pool, a motion pool, and an emote pool.

The persona generation prompt is transmitted from the generation server device 200 to the processing server device 100. The avatar generator 131 selects preset data of element data for the generated variable from the persona generation prompt, and generates an avatar using the selected preset data (step S110).

The avatar generator 131 may input a persona generation prompt and a plurality of pieces of element data into a machine learning model that has been trained using data related to a real person as learning data, and generate an avatar that imitates a real person based on an output from the machine learning model. The machine learning model may be trained using, for example, data in which a persona generation prompt and a plurality of pieces of element data are associated with data related to a real person as learning data. Accordingly, in a case where data related to a real person is input, the machine learning model can output a persona generation prompt and a plurality of pieces of element data corresponding to the data related to the real person as learning data in a case where the input data matches the data related to the real person as learning data. Accordingly, the avatar generator 131 can generate an avatar that imitates a real person by generating an avatar based on the persona generation prompt output from the machine learning model and a plurality of pieces of element data.

The avatar generator 131 may construct a virtual three-dimensional space and generate and move an avatar within the three-dimensional space based on the persona generation prompt. For example, in a case where an avatar movement pattern is set as element data of the avatar, the avatar generator 131 can select element data of the avatar movement pattern based on the avatar movement pattern in the persona generation prompt, and move the avatar in three-dimensional space based on the selected element data.

The avatar generator 131 may generate an avatar using a technology known as so-called deep fake. The avatar generator 131 may use a technology called three-dimensional computer graphics (3DCG) to construct a three-dimensional space through computer processing, and generate and move an avatar within the three-dimensional space.

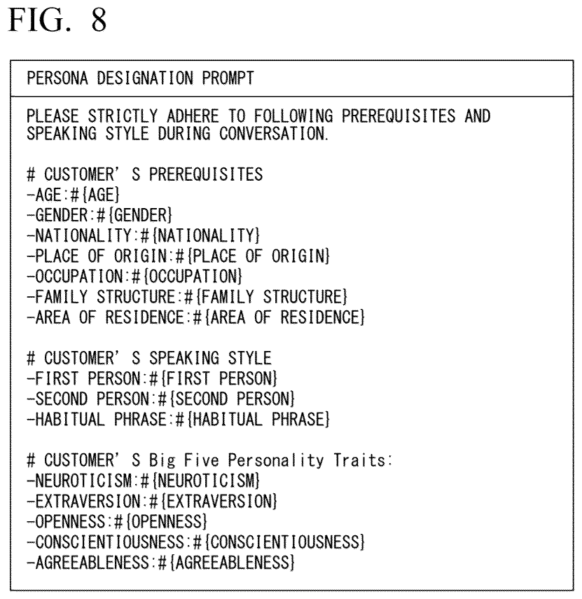

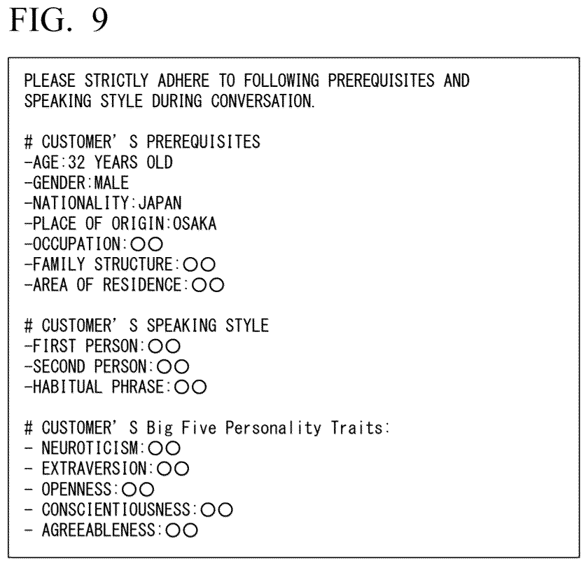

Next, the persona generator 211 generates a persona designation prompt (step S112). FIG. 8 is a diagram showing an example of a persona designation prompt in the embodiment. The persona generator 211 may input a variable corresponding to the persona generation prompt into the LLM, and generate a persona designation prompt based on an output of the LLM. The variable corresponding to the persona generation prompt may be selected based on a user's operation, or may be extracted from the persona generation prompt randomly or according to a predetermined rule. The persona generator 211 transmits the persona designation information as shown in FIG. 8 to the processing server device 100 based on the persona designation prompt. FIG. 9 is a diagram showing an example of persona designation information in the embodiment.

Next, the dialogue controller 120 controls a dialogue between the avatar and the user (step S114). At this time, the movement controller 130 reads out the element data based on the element data variables, and controls the avatar corresponding to the persona. The element data is stored as pool data, for example as shown in FIG. 7. The movement controller 130 reads data corresponding to the variables from, for example, avatar pool data, synthesized voice pool data, motion pool data, and emote pool data. The movement controller 130 reads out any of image data indicating the basic body features and clothing of various avatars from the avatar pool data, reads out any of element data for generating voices of various avatars from the synthesized voice pool data, reads out any of element data for generating motions corresponding to various facial expressions and emotions from the motion pool data, reads out any of element data for generating emotes corresponding to various facial expressions and emotions from the emote pool data, and controls the avatar using the plurality of types of element data that have been read out. The movement information 144 may include other information for moving the avatar. Other information may be default values for controlling the motion of the avatar, defined values for controlling the emote of the avatar, and default values for controlling the lip sync of the avatar. Accordingly, the dialogue controller 120 performs a role play through the dialogue between the user and the avatar. The utterance acquirer 121 acquires utterance information indicating a user's utterance, and the conversation history generator 125 stores the conversation history (step S116).

Next, the processing server device 100 determines whether or not to evaluate the user (step S118). In a case where the processing server device 100 does not evaluate the user, the processes of steps S114 and S116 are repeated. For example, in a case where the processing server device 100 detects a user's utterance of “evaluate the role play”, the processing server device 100 determines to evaluate the user and transmits the conversation history to the generation server device 200. The generation server device 200 evaluates the user based on the utterance information acquired by the utterance acquirer 121 (step S120). At this time, the generation server device 200 generates the evaluation prompt based on the conversation history acquired from the processing server device 100. The generation server device 200 may input the conversation history to an LLM that generates an evaluation prompt, and generate the evaluation prompt based on an output of the LLM. For example, in a case where a user describes a product in a role play, the generation server device 200 may input the conversation history and information stored in the product information database to an LLM that generates an evaluation prompt, and generate the evaluation prompt based on an output of the LLM that generates an evaluation prompt. The generation server device 200 outputs evaluation information to the processing server device 100 as a result of evaluating the conversation of the user based on the evaluation prompt (step S122). Accordingly, the processing server device 100 can transmit evaluation information to the user terminal device 300, and the user terminal device 300 can present the evaluation to the user.

The timing for evaluating a role play may be at the end of the role play, that is, the entire role play (such as a business negotiation), but is not limited thereto, and evaluation may be performed after each conversation rally (each round trip of conversation) during the role play. For example, at the start of a role play, the processing server device 100 allows the user to select an overall evaluation (end evaluation) or an individual evaluation. The overall evaluation is a process of evaluating the entire conversation history, and the individual evaluation is a process of evaluating each rally during the conversation (including a pair of inquiry and response of the conversation). In a case where the overall evaluation is selected, the processing server device 100 transmits the conversation history to the generation server device 200 at the timing when it detects a user's utterance, for example, “evaluate the role play”. In a case where the individual evaluation is selected, the processing server device 100 transmits the conversation history for one rally to the generation server device 200 at the timing when it detects a break in a rally during the conversation. The generation server device 200 stores the results of the individual evaluation performed based on the conversation history for one rally in the storage 220, and transmits the results of one or more individual evaluations to the processing server device 100 at the timing when the role play ends. Accordingly, the results of the individual evaluation can be presented to the user.

Further, the role play (such as a business negotiation) may be evaluated as a whole, and each conversation rally (each round trip of conversation) during the role play may be evaluated at the same time. At the start of a role play, for example, the user selects whether to perform both an overall evaluation and an individual evaluation in the processing server device 100. The processing server device 100 transmits a conversation history for one rally to the generation server device 200 at the timing when it detects a break in a rally during the conversation, and further transmits the conversation history to the generation server device 200 at the timing when it detects a user's utterance of “evaluate the role play”. The generation server device 200 stores the results of the individual evaluation performed based on the conversation history for one rally in the storage 220. The generation server device 200 transmits the result of the overall evaluation and the results of one or more individual evaluations to the processing server device 100 at the timing when the role play ends. Accordingly, the result of the overall evaluation and the result of the individual evaluation can be presented to the user on the same screen.

As described above, with the avatar generation system according to the embodiment, it is possible to store a plurality of pieces of element data indicating components of an avatar as a dialogue partner, receive persona information indicating a persona that characterizes the dialogue partner of a user, generate a persona generation prompt indicating characteristics of the persona based on the persona information, select element data for the persona generation prompt, and generate an avatar using the selected element data. According to the avatar generation system, it is possible to easily generate an avatar according to the attributes of a dialogue partner. According to the avatar generation system, for example, it is possible to easily increase the variation of attributes of dialogue partners for role-playing, and to realize role-playing according to the attributes of the dialogue partners.

The functions of the processing server device 100, the generation server device 200, and the user terminal device 300 in the above-mentioned embodiment may be realized by a computer. In this case, the function may be realized by recording a program for realizing the function on a computer-readable recording medium, and reading and executing the program recorded on the recording medium into a computer system. The term “computer system” here includes an OS and hardware such as a peripheral device. In addition, the term “computer-readable recording medium” refers to a portable medium such as a flexible disk, a magneto-optical disk, a ROM, or a CD-ROM, and a storage device such as a hard disk built into a computer system.

Furthermore, the term “computer-readable recording medium” may include a medium that dynamically holds the program for a short period, such as a communication line for transmitting the program via networks such as the Internet and communication lines such as telephone lines, and a medium that holds a program for a certain period, such as a volatile memory inside a computer system that is a server or a client in that case. Furthermore, the above program may be for realizing part of the functions described above, or may be capable of realizing the functions described above in combination with a program already recorded in a computer system, or may be realized using a programmable logic device such as a field programmable gate array (FPGA).

While preferred embodiments of the invention have been described and illustrated above, it should be understood that these are exemplary of the invention and are not to be considered as limiting. Additions, omissions, substitutions, and other modifications can be made without departing from the scope of the invention. Accordingly, the invention is not to be considered as being limited by the foregoing description and is only limited by the scope of the appended claims.

### EXPLANATION OF REFERENCES

1: Dialogue support system
100: Processing server device
110: Customer generator
111: Receiver
112: Customer definer
120: Dialogue controller
121: Utterance acquirer
122: Emotion parameter processor
123: Response prompt generator
124: Response text converter
125: Conversation history generator
130: Movement controller
131: Avatar generator
132: Voice generator
133: Voice tone information processor
134: Motion processor
135: Emote processor
136: Lip sync processor
140: Storage
141: Customer information
142: Response information
143: Voice information
144: Movement information
200: Generation server device
210: Generator
211: Persona generator
212: Response text generator
214: Unique information acquirer
220: Storage
221: Unique information
222: Element data
223: LLM information
300: User terminal device

What is claimed is:

1. An avatar generation system comprising:
a receiver configured to receive persona information indicating a persona that characterizes a dialogue partner of a user;
a persona generator configured to generate a persona generation prompt indicating characteristics of the persona based on the persona information received by the receiver using a large language model;
a storage storing a plurality of pieces of element data indicating components of an avatar as a dialogue partner;
an avatar generator configured to select the element data stored in the storage for the persona generation prompt generated by the persona generator and generate an avatar using the selected element data; and
an output unit configured to output the avatar corresponding to the persona based on the persona generation prompt generated by the persona generator.

2. The avatar generation system according to claim 1,
wherein the element data includes element data related to a face or a body, element data related to a voice, and element data related to a movement.

3. The avatar generation system according to claim 1,
wherein the persona information includes a nationality or a place of origin,
the persona generator is configured to input existing items including a nationality or a place of origin of the persona as the persona information into the large language model, and generate the persona generation prompt based on an output of the large language model,
the element data includes element data for generating a voice, and
the element data for generating the voice includes synthesized voice data corresponding to elements including a speaking style or a tone corresponding to the nationality or the place of origin of the persona, the avatar generation system further comprising:
a voice generator configured to generate voice data in a language corresponding to a nationality or a place of origin based on the persona generation prompt generated by the persona generator and the persona information.

4. The avatar generation system according to claim 3,
wherein the element data for generating the voice includes a plurality of pieces of element data corresponding to each of a plurality of languages, and
the voice generator is configured to select one of the plurality of pieces of element data corresponding to each of the plurality of languages based on the nationality or the place of origin included in the persona information.

5. The avatar generation system according to claim 3,
wherein element data for generating a motion represents an avatar motion corresponding to a nationality or a place of origin, the avatar generation system further comprising:
a motion processor configured to generate an avatar motion corresponding to a nationality or a place of origin based on the persona generation prompt generated by the persona generator and the persona information.

6. The avatar generation system according to claim 1,
wherein the element data includes image information and descriptive text information for each element of the avatar, and
the avatar generator is configured to collate the persona generation prompt with the descriptive text information and select or generate image information of the avatar for the persona based on a collation result.

7. The avatar generation system according to claim 1,
wherein the avatar generator is configured to input the persona generation prompt and the plurality of pieces of element data into a machine learning model that has been trained using data related to a real person as learning data, and generate the avatar that imitates a real person based on an output from the machine learning model.

8. The avatar generation system according to claim 1,
wherein the avatar generator is configured to construct a virtual three-dimensional space and generate and move the avatar within the three-dimensional space based on the persona generation prompt.

9. An avatar generation method comprising:
a step in which an avatar generation system stores, in a storage, a plurality of pieces of element data indicating components of an avatar as a dialogue partner of a user;
a step in which the avatar generation system receives persona information indicating a persona that characterizes the dialogue partner of the user;
a step in which the avatar generation system generates a persona generation prompt indicating characteristics of the persona based on the received persona information using a large language model;
a step in which the avatar generation system selects the element data stored in the storage for the generated persona generation prompt and generates an avatar using the selected element data; and
a step in which the avatar generation system outputs the avatar corresponding to the persona based on the generated persona generation prompt.

10. A non-transitory computer-readable storage medium storing a program that causes a computer of an avatar generation system to execute:
a step in which the avatar generation system stores, in a storage, a plurality of pieces of element data indicating components of an avatar as a dialogue partner of a user;
a step in which the avatar generation system receives persona information indicating a persona that characterizes the dialogue partner of the user;
a step in which the avatar generation system generates a persona generation prompt indicating characteristics of the persona based on the received persona information using a large language model;
a step in which the avatar generation system selects the element data stored in the storage for the generated persona generation prompt and generates an avatar using the selected element data; and
a step in which the avatar generation system outputs the avatar corresponding to the persona based on the generated persona generation prompt.
